(19) United States
(12) Patent Application Publication
(10) Pub. No.: US 2014/0292460 A1
(43) Pub. Date: Oct. 2, 2014

(54) INDUCTOR AND METHOD FOR MANUFACTURING THE SAME

(71) Applicant: Samsung Electro-Mechanics Co., Ltd., Suwon-si (KR)

(72) Inventors: Ho Yoon KIM, Suwon-si (KR); Myeong Gi KIM, Suwon-si (KR); Il Jin PARK, Suwon-si (KR); Jin Woo HAHN, Suwon-si (KR); Min Kyoung CHEON, Suwon-si (KR)

(73) Assignee: SAMSUNG ELECTRO-MECHANICS CO., LTD., Suwon-si (KR)

(21) Appl. No.: 14/081,472

(22) Filed: Nov. 15, 2013

(30) Foreign Application Priority Data
Mar. 29, 2013 (KR) 10-2013-0034678

(51) Int. Cl. H01F 27/245; H01F 41/04; H01F 27/28

(52) U.S. Cl. CPC H01F 27/245; H01F 27/2804; H01F 41/043
USPC 336/178; 336/200; 156/280; 156/246

(57) ABSTRACT

The present invention relates to an inductor. An inductor in accordance with an embodiment of the present invention includes: a ferrite-organic body; an internal electrode laminated on the ferrite-organic body along a thickness direction of the ferrite-organic body to have a multilayer structure; a metal-organic body constituting a device body with the ferrite-organic body by covering the ferrite-organic body; and an external electrode covering the device body to be electrically connected to the internal electrode.

### CROSS-REFERENCE TO RELATED APPLICATIONS

Claim and incorporate by reference domestic priority application and foreign priority application as follows:

This application claims the benefit under 35 U.S.C. Section 119 of Korean Patent Application Serial No. 10-2013-0034678, entitled filed Mar. 29, 2013, which is hereby incorporated by reference in its entirety into this application.

### BACKGROUND OF THE INVENTION

1. Field of the Invention

The present invention relates to an inductor and a method for manufacturing the same, and more particularly, to an inductor with improved inductance characteristics and a method for manufacturing the same.

2. Description of the Related Art

A multilayer power inductor is mainly used in a power circuit such as a DC-DC converter of a portable electronic device and particularly used in a high current due to its characteristics of suppressing magnetic saturation of the inductor in terms of material and structure. Since the multilayer power inductor has a disadvantage that inductance is greatly changed according to application of a current compared to a wire-wound power inductor but is advantageous to miniaturization and thinning, it can respond to the recent trend of electronic components.

A typical multilayer power inductor is manufactured by laminating magnetic sheets having internal electrodes printed thereon to form a device body and forming external electrodes on the surface of the device body to be electrically connected to the internal electrodes. Here, the magnetic sheets are made of a composite containing ferrite powder. Further, a gap layer may be selectively formed on the device body to reduce changes in inductance against external currents.

However, when using ferrite powder as a magnetic material of the multilayer power inductor as above, since the magnetic moment of the ferrite constituting elements is determined and thus there are limitations in increasing a saturation magnetization (Ms), it is difficult to implement a higher saturation magnetization for improvement of bias. Further, since the inductance characteristics can be improved by relatively increasing a magnetic material filling density in the device body to improve permeability, it is needed to improve the structure of the inductor to increase the magnetic material filling density.

### RELATED ART DOCUMENT

### Patent Document

Patent Document 1: Japanese Patent Laid-Open No. 2003-282328

### SUMMARY OF THE INVENTION

The present invention has been invented in order to overcome the above-described problems and it is, therefore, an object of the present invention to provide an inductor that can improve inductance characteristics and a method for manufacturing the same.

It is another object of the present invention to provide an inductor having a structure that can improve the overall permeability of a magnetic layer constituting a device body of the inductor and a method for manufacturing the same.

In accordance with one aspect of the present invention to achieve the object, there is provided an inductor including: a ferrite-organic body; an internal electrode laminated on the ferrite-organic body along a thickness direction of the ferrite-organic body to have a multilayer structure; a metal-organic body constituting a device body with the ferrite-organic body by covering the ferrite-organic body; and an external electrode covering the device body to be electrically connected to the internal electrode.

In accordance with an embodiment of the present invention, the metal-organic body may be made of a metal-organic composite, wherein the metal-organic composite may include one metal of iron (Fe), a Fe-based alloy, and a Fe-based amorphous and at least one organic material of a resin, a curing agent, and a silane coupling agent.

In accordance with an embodiment of the present invention, the metal-organic body may be made of a metal-organic composite including a crystalline epoxy resin as an organic material.

In accordance with an embodiment of the present invention, a ratio of the thickness of the metal-organic body to the thickness of the device body may be 0.2 to 0.8.

In accordance with an embodiment of the present invention, the metal-organic body may be made of a metal-organic composite whose metal content is 65 wt % to 95 wt %.

In accordance with an embodiment of the present invention, the ferrite-organic body may be made of a ferrite-organic composite, wherein the ferrite-organic composite may include ferrite powder, an organic binder, a dispersant, and a plasticizer.

In accordance with an embodiment of the present invention, the ferrite-organic body may be formed by laminating a plurality of ferrite sheets having the internal electrodes thereon.

In accordance with an embodiment of the present invention, a gap layer may further provided between the ferrite-organic body and the metal-organic body.

In accordance with another aspect of the present invention to achieve the object, there is provided a method for manufacturing an inductor, including the steps of: preparing a plurality of ferrite sheets having internal electrodes on the surface; manufacturing a ferrite-organic body by laminating and pressing the ferrite sheets so that the internal electrodes formed on the respective ferrite sheets form a single multilayer coil; manufacturing a device body by forming a metal-organic body to cover the ferrite-organic body; and forming an external electrode on the surface of the device body to be electrically connected to the multilayer coil.

In accordance with an embodiment of the present invention, the step of forming the metal-organic body may include the step of manufacturing a metal-organic composite including one metal of iron (Fe), a Fe-based alloy, and a Fe-based amorphous and at least one organic material of a resin, a curing agent, and a silane coupling agent.

In accordance with an embodiment of the present invention, the step of forming the metal-organic body may include the step of preparing a metal-organic composite including a crystalline epoxy resin.

In accordance with an embodiment of the present invention, the step of forming the metal-organic body may be performed using a metal-organic composite whose metal content is 65 wt % to 95 wt %.

In accordance with an embodiment of the present invention, the step of forming the metal-organic body may be performed so that a ratio of the thickness of the metal-organic body to the thickness of the device body is 0.2 to 0.8.

In accordance with an embodiment of the present invention, the step of preparing the ferrite sheets may include the steps of manufacturing a ferrite-organic composite including ferrite powder, an organic binder, a dispersant, and a plasticizer and film-casting the ferrite-organic composite.

In accordance with an embodiment of the present invention, the method for manufacturing an inductor may further include the step of forming a gap layer between the ferrite-organic body and the metal-organic body.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing an inductor in accordance with an embodiment of the present invention;

FIG. 2 is a view showing a method for manufacturing an inductor in accordance with an embodiment of the present invention;

FIGS. 3a to 3d are views for explaining a process of manufacturing an inductor in accordance with an embodiment of the present invention; and

FIG. 4 is a view showing a modified example of the inductor in accordance with an embodiment of the present invention.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Further, embodiments to be described throughout the specification will be described with reference to cross-sectional views and/or plan views, which are ideal exemplary drawings of the present invention. In the drawings, the thicknesses of layers and regions may be exaggerated for the effective explanation of technical contents. Therefore, the exemplary drawings may be modified by manufacturing techniques and/or tolerances. Therefore, the embodiments of the present invention are not limited to the accompanying drawings, and can include modifications to be generated according to manufacturing processes. For example, an etched region shown at a right angle may be formed in the rounded shape or formed to have a predetermined curvature.

Hereinafter, an inductor and a method for manufacturing the same in accordance with an embodiment of the present invention will be described in detail with reference to the accompanying drawings.

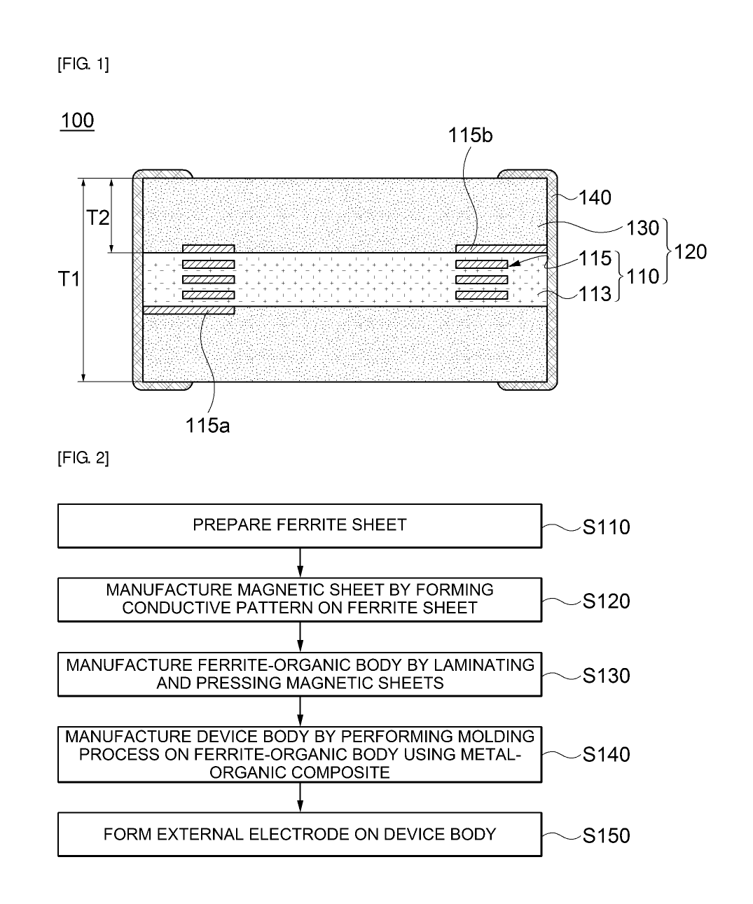

FIG. 1 is a view showing an inductor in accordance with an embodiment of the present invention. Referring to FIG. 1, an inductor 100 in accordance with an embodiment of the present invention, which is a multilayer power inductor, may include a ferrite-organic body 110, a metal-organic body 130, and an external electrode 140.

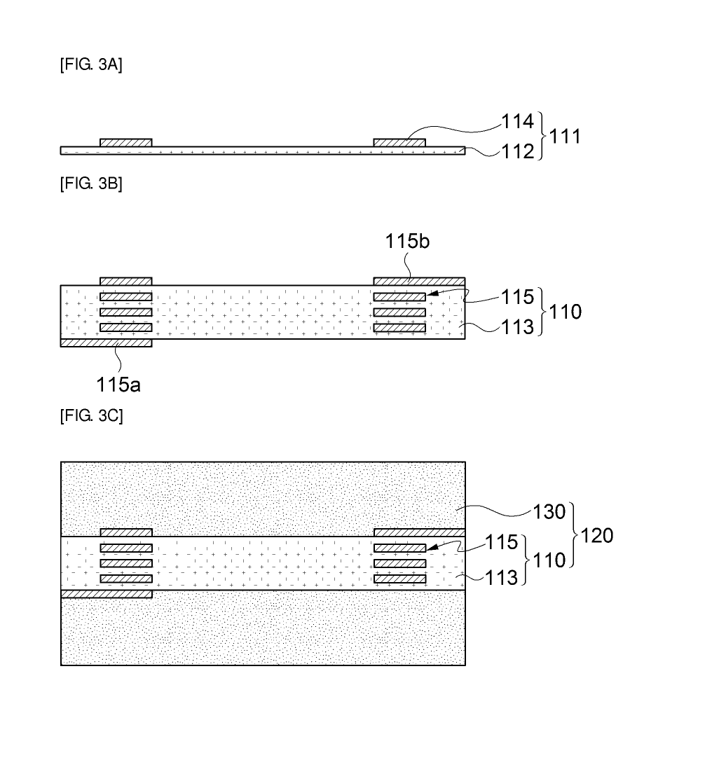

The ferrite-organic body 110 may be disposed in the internal center of the inductor 100 to form a core layer of the inductor 100. The ferrite-organic body 110 may have a sheet laminate 113 and an internal electrode 115 provided on the sheet laminate 113. The sheet laminate 113 may be a resultant product formed by laminating and pressing a plurality of ferrite sheets 112 of FIG. 3a having conductive patterns 114 of FIG. 3 for formation of the internal electrode 115.

Meanwhile, the sheet laminate 113 may be made of a ferrite-organic composite. The ferrite-organic composite may be a material containing ferrite powder, an organic binder, a dispersant, and a plasticizer.

The internal electrode 115 may have a multilayer coil structure with a lamination height along a lamination direction of the sheet laminate 113. The internal electrode 115 may have a first electrode 115a formed on one surface of the sheet laminate 113 and a second electrode 115b formed on the other surface of the sheet laminate 113. The first and second electrodes 115a and 115b, which are provided to electrically connect the internal electrode 115 to the external electrode 140, may be formed to be exposed outside the ferrite-organic body 110. Accordingly, the first and second electrodes 115a and 115b may be disposed on the boundary of the ferrite-organic body 110 and the metal-organic body 130.

The metal-organic body 130 may cover both surfaces of the ferrite-organic body 110 with a predetermined thickness. The thicknesses of the metal-organic bodies 130, which cover the both surfaces of the ferrite-organic body 110, may be substantially equal to each other. Accordingly, the metal-organic body 130 may constitute a device body 120 of the inductor 100, which has a substantially hexahedral shape, with the ferrite-organic body 110.

Further, it may be preferred that metal magnetic powder of the metal-organic composite for the manufacture of the metal-organic body 130 is an iron (Fe)-based metal. A saturation magnetization value of the Fe metal is about 218 (emu/g), which is almost three times as ferrite powder synthesized in a spinel phase through a typical calcination reaction. Referring to Table 1, when containing more than 99 wt % of Fe as the metal-organic composite, it is checked that the saturation magnetization value is secured by greater than 192 (emu/g), but in this case, there may be problems that processability of the metal-organic composite is deteriorated and electrical characteristics aren't secured. Therefore, it may be preferred to use various types of Fe-based alloys etc. Here, in case of an alloy as the metal magnetic powder, it is checked that the saturation magnetization value Ms is secured by greater than 150 (emu/g) when the Fe content is more than about 50 wt %. Although not shown in Table 1, when the Fe content is less than about 50 wt %, it is checked that the saturation magnetization value Ms is reduced to less than 100 (emu/g).

TABLE 1

| | | Saturation magnetization |
|---|---|---|
| No | Type of metal magnetic material | value (Ms) |
| 1 | Fe (more than 99 wt %) | 192 (emu/g) |
| 2 | Fe-(3~10 wt %) Si based | 172 (emu/g) |
| 3 | Fe—Si—Al sendust based | 115 (emu/g) |
| 4 | Fe—Ni based (more than | 150 (emu/g) |
| | 50 wt % of Fe) | |
| 5 | Fe—Si—Cr based | 180 (emu/g) |
| 6 | Fe—Si—B—Cr amorphous based | 145 (emu/g) |

The external electrode 140 may be used as a connection terminal for mounting the device body 120 on an external electronic device (not shown). For this, the external electrode 140 may be formed on the surface of the device body 120. The external electrode 140 may consist of a portion electrically connected to the first electrode 115a on one end of the device body 120 and a portion electrically connected to the second electrode 115b on the other end of the device body 120.

Meanwhile, the main characteristics of the power inductor are initial inductance Ls at 1 MHz and DC current Isat at which the inductance drops 30% from its initial value according to application of the DC current. These two characteristic values tend to be inversely proportional to each other in the same chip design. Therefore, a value obtained by multiplying the Ls value and the Isat value may be used as an indicator of magnetic energy efficiency in the inductor. That is, the Ls×Isat value may be used as an indicator of deterioration of the characteristic values of the inductor due to concentration of a magnetic flux on a specific portion.

Further, it is possible to improve the characteristics of the inductor by adjusting the thickness of the metal-organic body 130 (hereinafter, referred to as ‘a second thickness’: T2) with respect to the thickness of the device body 120 (hereinafter, referred to as ‘a first thickness’: T1) of the inductor 100. Table 2 shows the Ls, Isat, and Ls×Isat values according to the ratio of the second thickness T2 to the first thickness T1. When the ratio of the second thickness T2 to the first thickness T1 is less than 20%, it is checked that the Ls is increased but the Isat is greatly decreased. On the other hand, when the ratio of the second thickness T2 to the first thickness T1 is more than 80%, it is checked that the Ls is greatly decreased and the Isat is also decreased. Considering that an approximate average value of the Ls×Isat value of the power inductor is greater than 1.6, it may be preferred that the ratio of the second thickness T2 to the first thickness T1 is 0.2 to 0.8.

TABLE 2

| | | | Ls (μH) (on | | |
|---|---|---|---|---|---|
| No | T1 (mm) | T1/T2 | 1 MHz) | Isat (A) | Ls × Isat |
| 1 | 1.0 | 20 | 2.30 | 0.17 | 0.39 |
| 2 | 1.0 | 30 | 1.91 | 1.66 | 1.66 |
| 3 | 1.0 | 40 | 1.57 | 2.04 | 2.04 |
| 4 | 1.0 | 50 | 1.21 | 2.35 | 2.35 |
| 5 | 1.0 | 60 | 1.08 | 2.27 | 2.27 |
| 6 | 1.0 | 70 | 0.96 | 2.11 | 2.11 |
| 7 | 1.0 | 80 | 0.72 | 1.42 | 1.42 |

As described above, the inductor 100 in accordance with an embodiment of the present invention may include the ferrite-organic body 110 having the internal electrode 115 and the metal-organic body 130 containing the metal magnetic powder and constituting the device body 120 with the ferrite-organic body 110 while covering the ferrite-organic body 110. In this case, it is possible to greatly improve permeability by constituting the device body 120 with the metal-organic body 130 which uses metal magnetic powder having a relatively higher saturation magnetization value than typical ferrite powder. Accordingly, the inductor in accordance with the present invention can have a structure with improved inductance characteristics by forming the body in the portion, where the internal electrode is formed, with the ferrite-organic composite containing ferrite magnetic powder and forming the body in the remaining portion with the metal-organic composite containing metal magnetic powder having a higher saturation magnetization value than ferrite powder to improve permeability compared to the case in which the entire device body is formed of ferrite powder.

Further, the inductor 100 in accordance with an embodiment of the present invention can satisfy the reference specifications of the characteristics of the inductor by adjusting the ratio of the thickness T2 of the metal-organic body 130 to the thickness T1 of the device body 120 to 0.2 to 0.8 while constituting the device body 120 with the ferrite-organic body 110, which is a core layer, and the metal-organic body 130, which covers the ferrite-organic body 110. Accordingly, the inductor in accordance with the present invention can have a structure with improved chip characteristics as well as improved inductance characteristics by adjusting the thickness of the metal-organic body relative to the thickness of the device body to the optimal range.

Continuously, a method for manufacturing an inductor in accordance with an embodiment of the present invention will be described in detail. Here, descriptions overlapping with those of the above-described inductor 100 may be omitted or simplified.

FIG. 2 is a flowchart showing a method for manufacturing an inductor in accordance with an embodiment of the present invention, and FIGS. 3a to 3d are views for explaining a process of manufacturing an inductor in accordance with an embodiment of the present invention.

Referring to FIGS. 2 and 3a, a ferrite sheet 112 may be prepared (S110). The step of preparing the ferrite sheet 112 may include the steps of preparing a ferrite-organic composite and forming the ferrite-organic composite into a sheet by film-casting the ferrite-organic composite. The ferrite-organic composite may be slurry prepared by mixing ferrite powder, an organic binder, a dispersant, a plasticizer, etc. with an organic solvent. The organic binder may be polyvinyl butyrate (PVB) or an acrylic material.

A magnetic sheet 111 may be manufactured by forming a conductive pattern 114 on the ferrite sheet 112 (S120). The step of forming the conductive pattern 114 may be performed by performing the steps of forming a via hole in the ferrite sheet 112 and printing a conductive paste on the ferrite sheet 112. The metal paste may be a metal paste containing copper (Cu), silver (Ag), nickel (Ni), etc. A plurality of magnetic sheets 111 may be manufactured by repeating the above process of the magnetic sheet 111.

Referring to FIGS. 2 and 3b, a ferrite-organic body 110 may be manufactured by laminating and pressing the magnetic sheets 111 (S130). The step of manufacturing the ferrite-organic body 110 may be performed by laminating the magnetic sheets 111 to manufacture a sheet laminate 113 and pressing the sheet laminate 113. At this time, the step of manufacturing the sheet laminate 113 may laminate the magnetic sheets 111 so that the conductive pattern 114 is exposed to the outer surface of the finally manufactured sheet laminate 113. That is, the magnetic sheets 111 may be laminated after being aligned so that the sheet laminate 113 has a first internal electrode 115a disposed on one surface of the ferrite-organic body 110 and a second internal electrode 115b disposed on the other surface of the ferrite-organic body 110.

Through the above process, an internal electrode 115 having a multilayer coil structure can be manufactured on the sheet laminate 113 by laminating the conductive patterns 114 along a lamination direction of the magnetic sheets 111.

Referring to FIGS. 2 and 3c, a device body 120 may be manufactured by performing a molding process using a metal-organic composite on the ferrite-organic body 110 (S140). The device body 120 may be manufactured using a molding process. More specifically, the device body 120 may be manufactured by preparing the metal-organic composite, filling the metal-organic composite in a predetermined mold (not shown), positioning the ferrite-organic body 110 in the mold, and pressing the metal-organic composite to fit the metal-organic composite into the mold.

Meanwhile, the step of preparing the metal-organic composite may be performed by mixing one metal powder of iron (Fe), a Fe-based alloy, and a Fe-based amorphous with at least one organic material of a resin, a curing agent, and a silane coupling agent. It may be preferred that the resin is a crystalline epoxy resin. Since the crystalline epoxy resin has a high adhesion property, a glass transition temperature Tg of greater than about 100° C., and a low melting point of less than about 100° C., it can secure strong adhesion with the Fe-based metal. This is because it is possible to secure a low coefficient of thermal expansion due to the relatively strong adhesion of the crystalline epoxy. Like Table 3, when using the crystalline epoxy resin, compared to the case using an amorphous epoxy resin, it is checked that the coefficient of thermal expansion can be reduced to less than about 20.0 (μm/m° C.). Therefore, it is possible to secure strong resistance against an impact applied to the manufactured inductor, such as a solder crack, by using a crystalline epoxy resin as the resin.

TABLE 3

| | | Coefficient of thermal |
|---|---|---|
| No | Type of epoxy | expansion (CTE) |
| 1 | Crystalline BPF epoxy | 16.9 (μm/m° C.) |
| 2 | Crystalline BP epoxy | 17.5 (μm/m° C.) |
| 3 | Amorphous OCN epoxy | 23.2 (μm/m° C.) |
| 4 | Amorphous modified epoxy-1 | 27.5 (μm/m° C.) |
| 5 | Amorphous modified epoxy-2 | 28.3 (μm/m° C.) |

Further, in the step of preparing the metal-organic composite, it may be preferred that the content of the metal is adjusted to about 65 to 95 wt % based on the composite. Referring to Table 4, when the content of the metal is less than about 65 wt % based on the metal-organic composite, it is impossible to secure a desired inductance due to a great reduction in permeability. In contrast, when the content of the metal exceeds about 95 wt % based on the metal-organic composite, since an insulation property of the metal-organic composite isn't secured, a local current path between the metals in the metal-organic composite occurs. Thus, it is impossible to secure the characteristics of the inductor due to an increase in eddy current loss.

TABLE 4

| | Metal | Organic material | | |
|---|---|---|---|---|
| No | content (wt %) | content (wt %) | Permeability | Remarks |
| 1 | More than 95 | Less than 5 | More than 40 | Conducting |
| | | | | problem |
| | | | | occurred |
| 2 | 85~95 | 5~15 | 30~40 | |
| 3 | 70~85 | 15~30 | 15~30 | |
| 4 | 65~70 | 30~35 | 5~15 | |
| 5 | Less than 65 | More than 35 | Less than 5 | |

Referring to FIGS. 2 and 3d, an external electrode 140 may be formed on the device body 120 (S150). The step of forming the external electrode 140 may be performed by forming a metal layer, which is electrically connected to the internal electrode 115 of the device body 120, on both ends of the resultant product using a plating process, a dipping process, etc.

As described above, the method for manufacturing an inductor 100 in accordance with an embodiment of the present invention can manufacture the metal-organic body 130, which is the remaining portion of the device body 120, using the composite containing metal magnetic powder having a relatively high saturation magnetization value after manufacturing the ferrite-organic body 110 of the device body 120, where the internal electrode 115 is positioned, using the composite containing ferrite magnetic powder. In this case, it is possible to manufacture an inductor having a structure with greatly improved permeability by constituting most of the device body with the metal-organic composite using metal magnetic powder having a relatively higher saturation magnetization value than typical ferrite powder. Accordingly, the method for manufacturing an inductor in accordance with the present invention can manufacture an inductor having a structure with improved inductance characteristics by forming the body in the portion, in which the internal electrode is positioned, using the ferrite-organic composite containing ferrite magnetic powder and forming the body in the remaining portion using the metal-organic composite containing metal magnetic powder having a higher saturation magnetization value than ferrite powder to increase permeability compared to the case in which the entire device body is formed of ferrite powder.

Further, the method for manufacturing an inductor 100 in accordance with an embodiment of the present invention can manufacture the ferrite-organic body 110 by a sheet lamination method and the metal-organic body 130 by a molding method. In this case, it is possible to mass-produce a device body for manufacture of a small inductor by manufacturing the device body through a complex process of a lamination method and a molding method. Accordingly, the method for manufacturing an inductor in accordance with the present invention can mass-produce a small device body of a power inductor by manufacturing a ferrite-organic body portion, which forms a core layer, using a lamination method and the remaining metal-organic body portion using a molding method.

Hereinafter, a modified example of the inductor in accordance with the above-described embodiment of the present invention will be described in detail. Here, descriptions overlapping with those of the inductor 100 described with reference to FIG. 1 may be omitted or simplified.

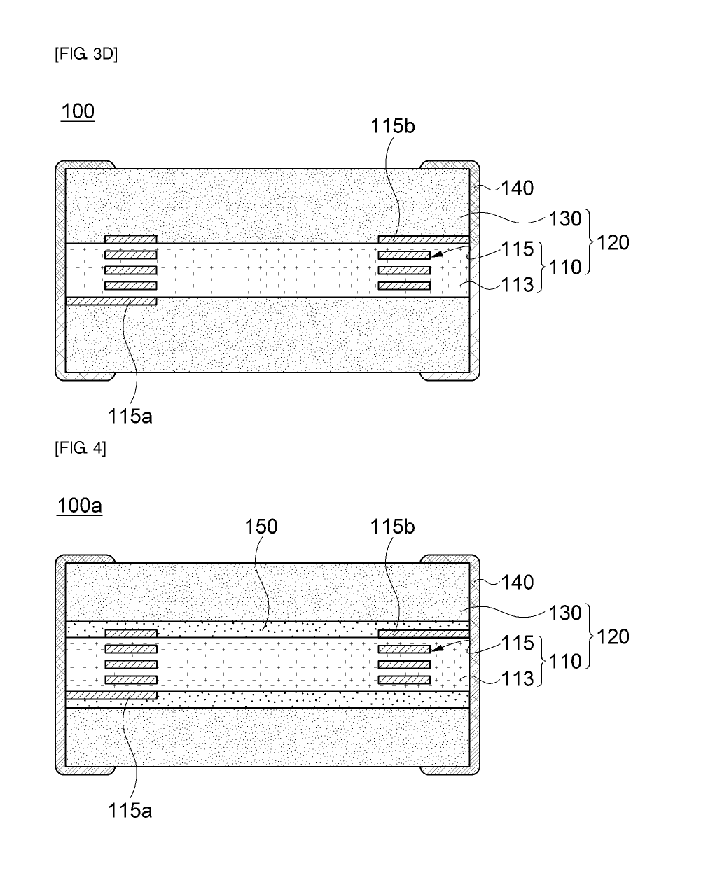

FIG. 4 is a view showing a modified example of the inductor in accordance with an embodiment of the present invention. Referring to FIG. 4, an inductor 100a in accordance with a modified example of the present invention may include a device body 120 consisting of a ferrite-organic body 110 and a metal-organic body 130 which covers both surfaces of the ferrite-organic body 110, external electrodes 140 formed on both ends of the device body 120 to be electrically connected to internal electrodes 115, and a gap layer 150 interposed between the ferrite-organic body 110 and the metal-organic body 130.

The gap layer 150 may be disposed in the direction parallel to magnetic sheets which form a sheet laminate 113 of the ferrite-organic body 110 along a lengthwise direction of the device body 120 inside the device body 120. The gap layer 150 may separate the ferrite-organic body 110 and the metal-organic body 130. Accordingly, magnetic fields generated in the respective regions separated by the gap layer 150 may be blocked by the gap layer 150 to minimize the flow of the magnetic fields between the regions.

A main component of a material of the gap layer 150 may be ZnCu ferrite or Zn—Ti dielectric, and CuO may be added or the content of Fe may be adjusted to secure sinterability. That is, it is preferred that the material of the gap layer 150 is a complete non-magnetic material in terms of functionality of the gap layer 150, but since the sinterability cannot be secured by the complete non-magnetic material in the process of manufacturing the device body, a material such as CuO can be added even considering that some magnetism is generated.

Since the typical Fe metal powder has a very high saturation magnetization value but has a permeability lower than that required for a multilayer power inductor, the number of turns of the internal electrode should be increased to implement the same inductance. This may cause an increase in R value for DC current. In order to appropriately adjust these contrary characteristics of the Fe metal powder, the gap layer 130 may be provided in the portion which is rapidly magnetically saturated due to concentration of a magnetic flux on the metal-organic body 130 to improve DC-bias characteristics. That is, the gap layer 150 may be provided between the portions 115a and 115b of the internal electrode 115, which are exposed on the sheet laminate 113, and the metal-organic body 130 to prevent an electrical short between the internal electrode 115 and the metal magnetic powder and improve the DC-bias characteristics even though the inductance may be somewhat reduced due to disconnection of the flow of the magnetic flux.

TABLE 5

| | Thickness of | Ls (μH) (on | | |
|---|---|---|---|---|
| Classification | device body | 1 MHz) | Isat (A) | Ls × Isat |
| Modified | 1.0 | 0.72 | 3.10 | 2.23 |
| example | | | | |
| Embodiment | 1.0 | 0.95 | 2.20 | 2.09 |
| Prior art | 1.0 | 1.86 | 0.90 | 1.67 |

Table 5 shows the characteristics of the inductor in accordance with an embodiment of the present invention in comparison with the prior art. Referring to Table 5, it is checked that the inductor 100 in accordance with the above-described embodiment of the present invention and the inductor 100a in accordance with the modified example have a relatively lower initial inductance value Ls than the conventional inductor having a laminated structure of ferrite sheets but have a relatively high Isat value and consequently have a high Ls×Isat value. Particularly, it is checked that the inductor 100a having the gap layer 150 has a highest Ls×Isat value and thus is a structure which uses magnetic energy most efficiently inside the chip.

The inductor in accordance with the present invention can have a structure with improved inductance characteristics by forming the body in the portion, where the internal electrode is formed, using the ferrite-organic composite containing ferrite magnetic powder and forming the body in the remaining portion using the metal-organic composite containing metal magnetic powder having a higher saturation magnetization value than the ferrite powder to increase permeability compared to the case in which the entire device body is formed of ferrite powder.

The inductor in accordance with the present invention can have a structure that can improve chip characteristics as well as inductance characteristics by adjusting the thickness of the metal-organic body relative to the thickness of the device body to the optimal range.

The method for manufacturing an inductor in accordance with the present invention can manufacture an inductor having a structure with improved inductance characteristics by forming the body in the portion, where the internal electrode is positioned, using the ferrite-organic composite containing ferrite magnetic powder and forming the body in the remaining portion using the metal-organic composite containing metal magnetic powder having a higher saturation magnetization value than the ferrite powder to increase permeability compared to the case in which the entire device body is formed of ferrite powder.

The method for manufacturing an inductor in accordance with the present invention can mass-produce the small device body of the power inductor by manufacturing the ferrite-organic body portion, which forms a core layer, using a lamination method and the remaining metal-organic body portion using a molding method.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. An inductor comprising:
a ferrite-organic body;
an internal electrode laminated on the ferrite-organic body along a thickness direction of the ferrite-organic body to have a multilayer structure;
a metal-organic body constituting a device body with the ferrite-organic body by covering the ferrite-organic body; and
an external electrode covering the device body to be electrically connected to the internal electrode.

2. The inductor according to claim 1, wherein the metal-organic body is made of a metal-organic composite, wherein the metal-organic composite comprises:
one metal of iron (Fe), a Fe-based alloy, and a Fe-based amorphous; and
at least one organic material of a resin, a curing agent, and a silane coupling agent.

3. The inductor according to claim 1, wherein the metal-organic body is made of a metal-organic composite including a crystalline epoxy resin as an organic material.

4. The inductor according to claim 1, wherein a ratio of the thickness of the metal-organic body to the thickness of the device body is 0.2 to 0.8.

5. The inductor according to claim 1, wherein the metal-organic body is made of a metal-organic composite whose metal content is 65 wt % to 95 wt %.

6. The inductor according to claim 1, wherein the ferrite-organic body is made of a ferrite-organic composite, wherein the ferrite-organic composite comprises ferrite powder, an organic binder, a dispersant, and a plasticizer.

7. The inductor according to claim 1, wherein the ferrite-organic body is formed by laminating a plurality of ferrite sheets having the internal electrodes thereon.

8. The inductor according to claim 1, further comprising:
a gap layer provided between the ferrite-organic body and the metal-organic body.

9. A method for manufacturing an inductor, comprising:
preparing a plurality of ferrite sheets having internal electrodes on the surface;
manufacturing a ferrite-organic body by laminating and pressing the ferrite sheets so that the internal electrodes formed on the respective ferrite sheets form a single multilayer coil;
manufacturing a device body by forming a metal-organic body to cover the ferrite-organic body; and
forming an external electrode on the surface of the device body to be electrically connected to the multilayer coil.

10. The method for manufacturing an inductor according to claim 9, wherein forming the metal-organic body comprises manufacturing a metal-organic composite including one metal of iron (Fe), a Fe-based alloy, and a Fe-based amorphous and at least one organic material of a resin, a curing agent, and a silane coupling agent.

11. The method for manufacturing an inductor according to claim 9, wherein forming the metal-organic body comprises preparing a metal-organic composite including a crystalline epoxy resin.

12. The method for manufacturing an inductor according to claim 9, wherein forming the metal-organic body is performed using a metal-organic composite whose metal content is 65 wt % to 95 wt %.

13. The method for manufacturing an inductor according to claim 9, wherein forming the metal-organic body is performed so that a ratio of the thickness of the metal-organic body to the thickness of the device body is 0.2 to 0.8.

14. The method for manufacturing an inductor according to claim 9, wherein preparing the ferrite sheets comprises:
manufacturing a ferrite-organic composite including ferrite powder, an organic binder, a dispersant, and a plasticizer; and
film-casting the ferrite-organic composite.

15. The method for manufacturing an inductor according to claim 9, further comprising:
forming a gap layer between the ferrite-organic body and the metal-organic body.
